(19) United States
(12) Patent Application Publication
(10) Pub. No.: US 2007/0297013 A1
(43) Pub. Date: Dec. 27, 2007

(54) Image reading apparatus, image forming apparatus and image reading method

(75) Inventor: Michihiro Nakagawa, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/651,079

(22) Filed: Jan. 9, 2007

(30) Foreign Application Priority Data
Jun. 23, 2006 (JP) 2006-173822

(51) Int. Cl. G06K 15/00

(52) U.S. Cl. 358/3.28

(57) ABSTRACT

An image reading apparatus, including: a scanner unit to read an original image to generate image data; an input unit to accept a direction to perform or not to perform predetermined image processing which affects image density to the image data; and a control unit to perform the predetermined image processing to the image data based on the direction on the input unit, wherein the control unit prohibits performing the predetermined image processing to the image data and outputting the image data when the control unit recognizes a presence of a security watermark in the original image based on the image data.

### CROSS REFERENCE TO RELATED APPLICATION

The present U.S. patent application claims a priority under the Paris Convention of Japanese patent application No. 2006-173822 filed on Jun. 23, 2006, which shall be a basis of correction of an incorrect translation.

### BACKGROUND

1. Field of the Invention

The present invention relates to an image reading apparatus and an image reading method which read an original image to generate image data and perform image processing to the image data. The present invention also relates to an image forming apparatus to make a copy by forming an image on a recording medium based on the image data to which the image processing has been performed.

2. Description of Related Art

In a recent information society, the reexamination of the security for electronic information has been strongly requested, and security guard concerning the Internet such as virus guard, access limitation and the like is busily performed. On the other hand, it is the present state of things that the security of paper documents has not been advanced yet, and the troubles that secret information is copied to be taken out to the outside have occurred. In such a situation, techniques for preventing forgery copying of the paper documents have been gradually begun to be proposed. For example, by the technique disclosed in JP 6-102797A, when an image of an original is formed, a watermark is formed with an optically transparent special ink at the same time as the formation of the image. The technique aims to prevent forgery copying by automatically stopping a copying operation if the watermark is optically detected when the original is actually copied.

A technique called as “a security watermark” has been now developed as a further higher technique for preventing the forgery copying. The security watermark is a technique of printing a concealed text 102 and a pattern 103 in the background portion of a copy 101 as shown in FIG. 8A when an original 100 is copied. Alternatively, there is another case where the original 100 is generated as image data by an application on a computer wherein the copy 101 (which is the original as a hard copy) is obtained by printing the concealed text 102 and the pattern 103 in the background portion of an image when the image data is printed as the hard copy. In both cases, generally, the concealed text 102 is formed of large dots capable of being detected by a scanner, and the pattern 103 is formed of small dots incapable of being detected by the scanner. The security watermark technique is made so that, when the original 100 is copied, the concealed text 102 looms up from the pattern 103 in the copy 101. Thereby, it can be easily judged that the copy 101 is a forgery copy.

However, the inventor of the present invention found that the security watermark technique had the following disadvantages in the future.

That is, if the pattern 103 of the copy 101 is not read, and if only the concealed text 102 is read and image data is generated when a second copy 104 is tried to be produced from the copy 101 as shown in FIG. 8B for a private use, private preservation and the like, then the concealed text 102 continue to be clearly copied in a third copy, a fourth copy and so forth. Consequently, forgery copying can be surely prevented and no problems are brought up.

On the other hand, if ground removal processing is performed to the obtained image data after the reading of the copy 101, then there is the possibility that the pattern 103 and the concealed text 102 of the copy 101 are recognized as the ground, and that the second copy 104 resembling the original 100 closely is produced as shown in FIG. 8C.

Similarly, if density is made to be thinner than a reference value when image formation is performed based on the obtained image data after the reading of the copy 101, then the density of the second copy 104 decreases in its entirety. Consequently, there is the possibility that only the portions of the pattern 103 and the concealed text 102 are erased, and that the second copy 104 resembling the original 100 closely is produced as a result.

As mentioned above, if the second copy 104 resembles the original 100 closely, then there is the possibility that forgery copying cannot be prevented in a third copy, a fourth copy and so forth.

### SUMMARY

It is one of objects of the present invention to prevent forgery copying in second, third . . . copies and in third, fourth . . . copies.

According to a first aspect of the invention, an image reading apparatus, comprises: a scanner unit to read an original image to generate image data; an input unit to accept a direction to perform or not to perform predetermined image processing which affects image density to the image data; and a control unit to perform the predetermined image processing to the image data based on the direction on the input unit, wherein the control unit prohibits performing the predetermined image processing to the image data and outputting the image data when the control unit recognizes a presence of a security watermark in the original image based on the image data.

Preferably, the control unit prohibits performing the predetermined image processing to the image data and outputting the image data by prohibiting the predetermined image processing or by stopping outputting the image data which has been subjected to the predetermined image processing.

Preferably, the predetermined image processing is to perform ground removal.

Preferably, the predetermined image processing is to make image density be thinner.

According to a second aspect of the invention, an image forming apparatus comprises: the image reading apparatus of claim 1; and a printer unit to record an image on a recording medium based on the image data to output the recording medium as a copy.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein;

FIG. 1 is a block diagram showing the schematic configuration of an image forming apparatus 1;

FIG. 2 is a view showing the external appearance of an operation panel unit 10;

FIG. 3 is a view showing an external appearance (first message) of a display panel unit 20;

FIG. 4 is another external appearance (second message) of the display panel unit 20;

FIG. 5 is a flow chart showing the copying control processing executed by a control unit 50 of a first embodiment with time;

FIG. 6 is a flow chart showing the copying control processing executed by the control unit 50 of a second embodiment with time;

FIG. 7 is a view showing a further external appearance (second message) of the display panel unit 20; and

FIGS. 8A, 8B and 8C are views for describing security watermark printing and the disadvantages thereof.

### DETAILED DESCRIPTION OF THE PREFERRED EMBODIMENTS

### First Embodiment

In the following, a first embodiment for implementing the present invention is described with reference to the attached drawings. However, the scope of the invention is not limited to the shown examples.

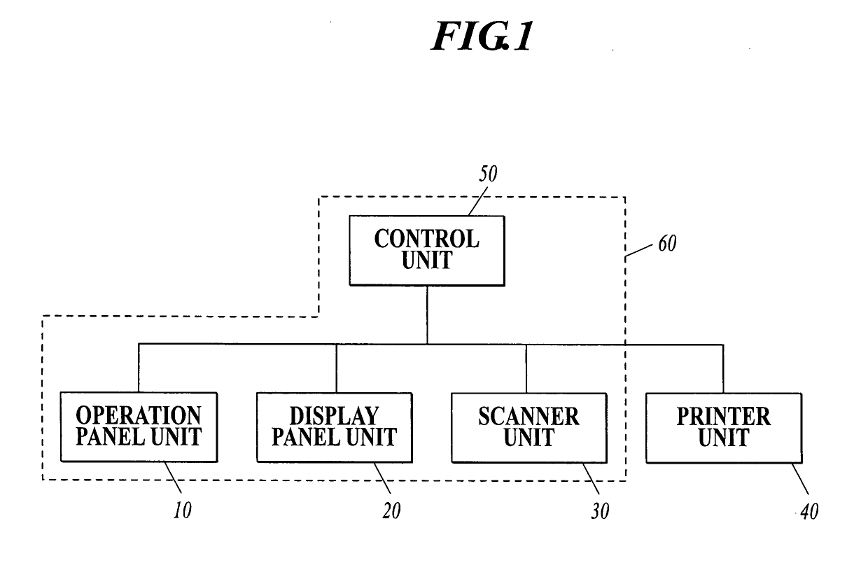

As shown in FIG. 1, an image forming apparatus 1 according to the present invention is composed of an image reading apparatus 60 and a printer unit 40, and the image reading apparatus 60 is composed of an operation panel unit 10, a display panel unit 20, a scanner unit 30, a control unit 50 and the like. The image forming apparatus 1 has the configuration in which the operation panel unit 10, the display panel unit 20, the scanner unit 30 and the printer unit 40 are severally connected with the control unit 50.

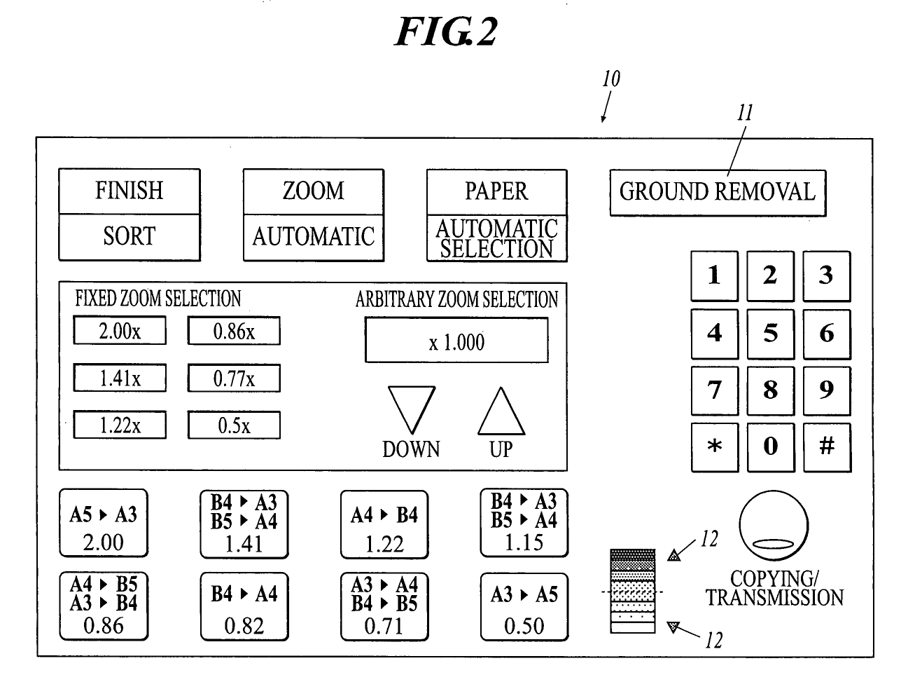

The operation panel unit 10 is composed of a touch panel, and constitutes a touch screen together with the display panel unit 20 by being disposed to be superimposed on the display panel unit 20. The touch screen displays a plurality of operation buttons (soft buttons) for setting various conditions at the time of reading an original image, copying the original image and the like by a control signal from the control unit 50, as shown in FIG. 2, for example. The image forming apparatus 1 is configured so that, when a user depresses the position corresponding to an operation button on the operation panel unit 10, the coordinate signal corresponding to the position may be transmitted to the control unit 50. The operation buttons include a ground removal direction button 11 for directing whether ground removal processing should be performed or not to an image read by the scanner unit 30, and a density changing direction button 12 for directing whether density changing processing should be performed to an image read by the scanner unit 30.

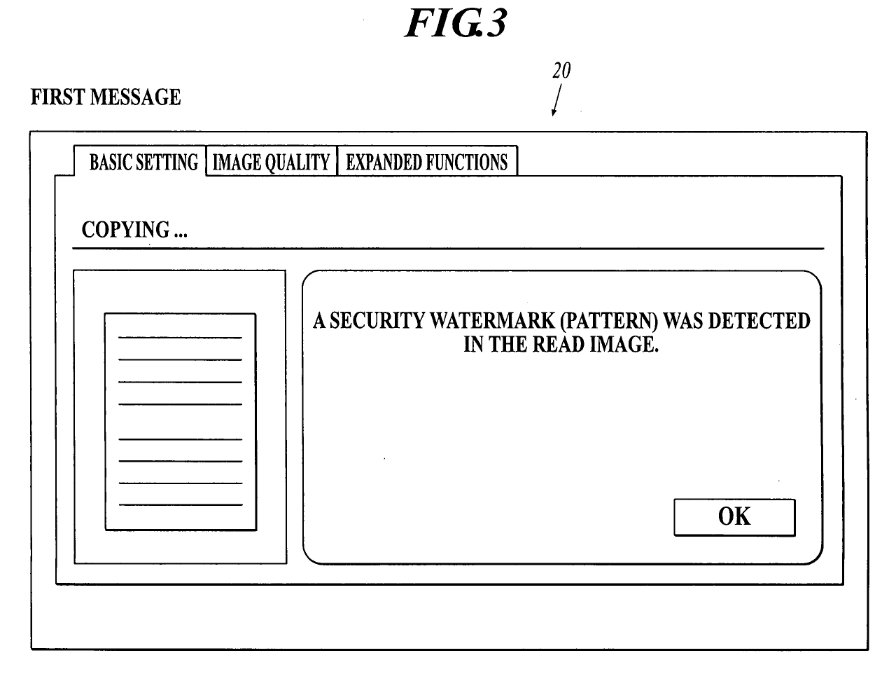

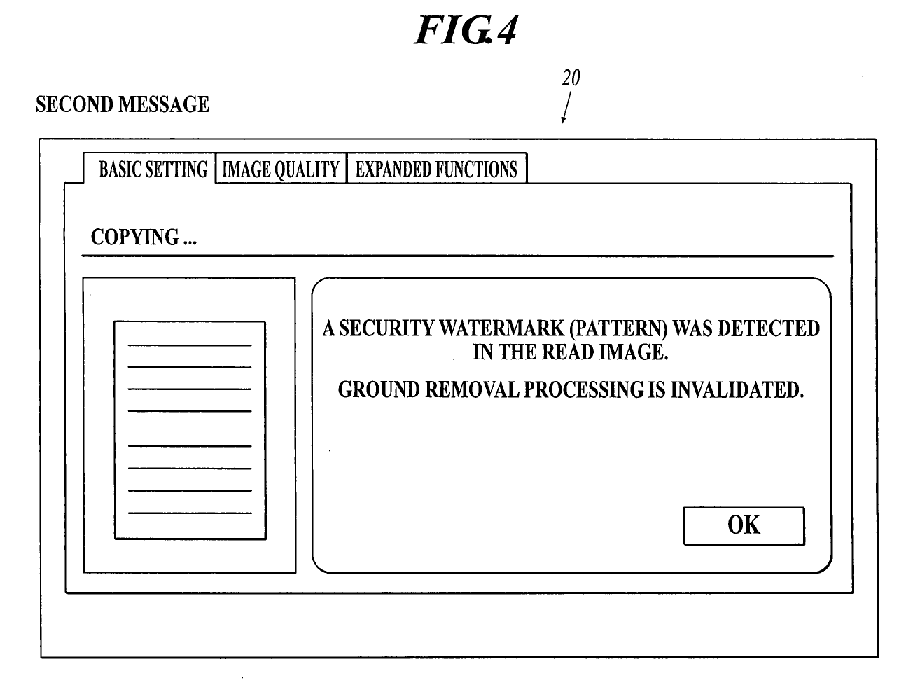

The display panel unit 20 is a section constituting a part of the touch screen as mentioned above, and is composed of a heretofore known liquid crystal panel or the like. The display panel unit 20 is configured to perform a display in accordance with a display signal transmitted from the control unit 50, and to display the situation at the time of reading an original (see FIG. 3), an indication to a user (see FIG. 4), and the like, as shown in FIGS. 3 and 4, for example, besides the example of FIG. 2.

The scanner unit 30 is a section composed of a heretofore known scanner. The scanner unit 30 is the one reading an image on an original to generate the image data thereof, and is configured to transmit the image data to the control unit 50.

The printer unit 40 is a section composed of a heretofore known laser printer or the like. The printer unit 40 is configured to record an image on a recording medium based on the transmitted content in accordance with a signal transmitted from the control unit 50, and to output the recording medium as a copy.

The control unit 50 is a section composed of a heretofore known central processing unit (CPU), a random access memory (RAM), a read only memory (ROM) and the like. The control unit 50 is configured so that various kinds of data, processing programs and the like may be stored in the ROM, and that the CPU may use the RAM as a work area while executing the processing in accordance with the processing program of the ROM.

The control unit 50, for example, receives a signal from the operation panel unit 10 and controls the operation of the scanner unit 30 and the printer unit 40 under the condition based on the received signal, or receives a signal from the operation panel unit 10 and makes the display panel unit 20 display the content based on the received signal. Moreover, the control unit 50 bears the function of receiving image data from the scanner unit 30 to perform desired image processing to the received image data in accordance with the signal from the operation panel unit 10, and the control unit 50 outputs the image data that has been subjected to the image processing to the printer unit 40 to make the printer unit 40 execute the copying of the original image.

To put it concretely, the control unit 50 is configured so that, when the control unit 50 receives a signal directing to perform ground removal from the ground removal direction button 11 of the operation panel unit 10, the control unit 50 may perform the ground removal processing of the image data. The ground removal processing means to perform γ correction processing especially to the ground portion of image data to adjust the brightness of the image, and the ground removal processing is the image processing that does not perform the printing of the ground portion.

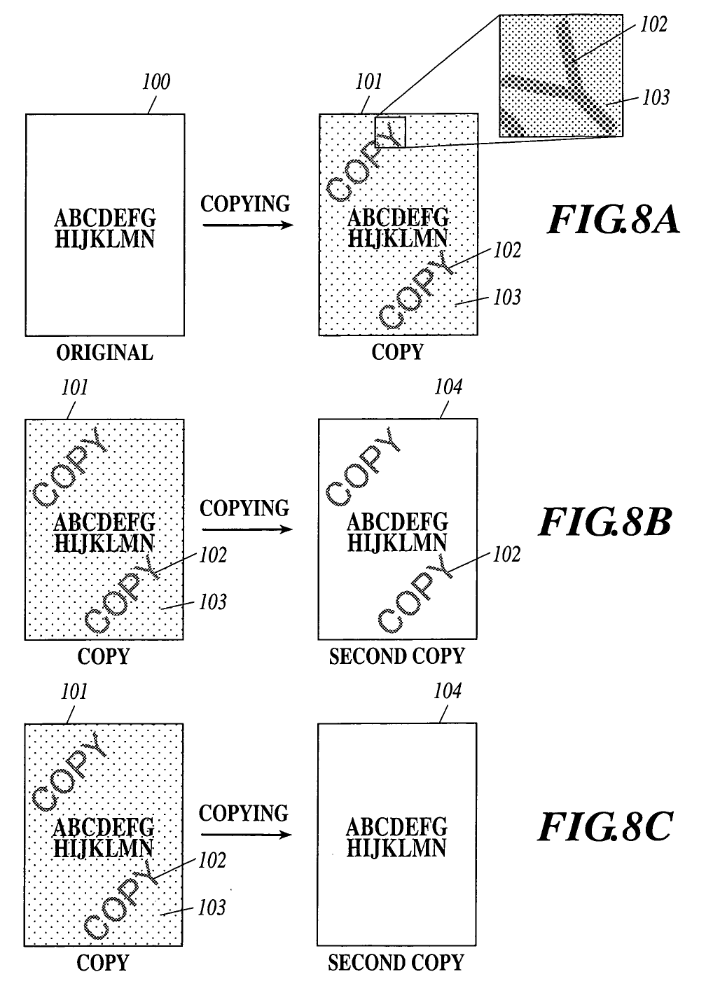

Then, the control unit 50 is configured so that many security watermark patterns may be previously registered (stored) in the ROM, and that the CPU may perform the pattern matching processing between the registered patterns and the security watermark pattern (corresponding to the pattern 103 in FIGS. 8A-8C) of the original image read by the scanner unit 30 to make it possible to detect whether there is any security watermark in the original image or not.

Hereupon, the control unit 50 is configured so that, when the control unit 50 recognizes that there is the security watermark pattern in the image based on the reading result of the scanner unit 30 if a direction to perform the ground removal processing is input onto the ground removal direction button 11, the control unit 50 may prohibit the ground removal processing.

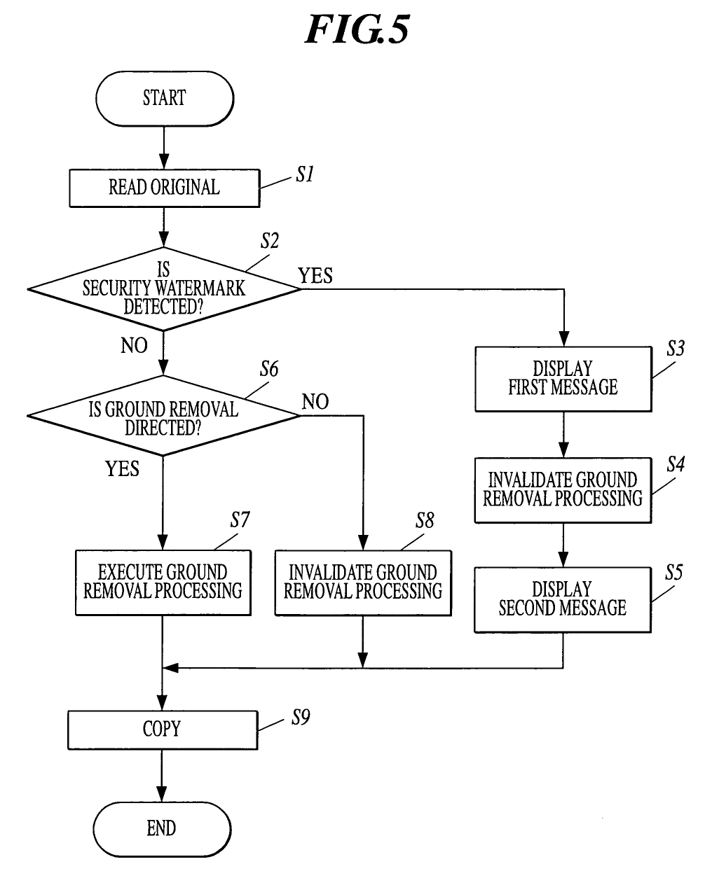

Next, the copying control processing that is executed by the control unit 50 in the image forming apparatus 1 is described with reference to FIG. 5.

When a signal directing the start of the copying of an original image is transmitted to the control unit 50 by an operation of the operation panel unit 10 by a user, the control unit 50 recognizes the direction, and makes the scanner unit 30 start the reading of the original image (Step S1). In this case, whenever the scanner unit 30 reads the original image, the scanner unit 30 sequentially performs the image processing of the reading result to transmit the reading result after the image processing to the control unit 50 as image data.

Next, at Step S2, the control unit 50 judges whether there is some security watermark pattern in the original image or not based on the image data transmitted from the scanner unit 30.

To put it concretely, the control unit 50 judges whether there is any repetition pattern (a dot pattern appearing repeatedly) in the original image or not. When the control unit 50 recognizes that there is a repetition pattern, the control unit 50 judges whether the repetition pattern agrees with any registered pattern or not.

If the control unit 50 recognizes that there is no repetition pattern in the original image or that, although there is a repetition patter in the original image, the repetition pattern does not agree with any of the registered patterns, as a result of the judgment at the Step SA2, then the control unit 50 recognizes that there is no security watermark pattern in the original image (Step S2; NO), and the control unit 50 shifts its processing to that at Step S6. On the other hand, if there is a repetition pattern of one of the registered patterns in the original image as the result of the judgment at the Step S2, then the control unit 50 recognizes that there is a security watermark pattern in the original image (Step S2; YES), and shifts its processing to that at Step S3.

In addition, in the processing at the Step S2, the control unit 50 may not judge whether the repetition pattern agrees with any of the registered patterns or not, and may recognize that there is a security watermark pattern in the original image at the time point when the control unit 50 recognizes that there is a repetition pattern in the original image. Alternatively, the control unit 50 may judge that there is a security watermark pattern in the original image at the time point when the control unit 50 identifies large dots and small dots in the original image to recognize the concealed text of the security watermark (corresponding to the concealed text 102 in the FIGS. 8A-8C) based on the contours of the large dots.

At the Step S3 the control unit 50 makes the display panel unit 20 display a first message indicating the fact that the security watermark pattern has been detected in the original image in a display mode shown in FIG. 3. In the state in which the display panel unit 20 displays the first message, when the user recognizes the first message to operate the display panel unit 20 (by depressing the “OK” portion in FIG. 3), or when the control unit 50 recognizes that a predetermined time has passed, the control unit 50 shifts its processing to that at Step S4.

At the Step S4, the control unit 50 invalidates ground removal processing by making the ground removal processing be prohibited lest the ground removal processing should be executed even if a direction to perform the ground removal processing is input onto the ground removal direction button 11, and then the control unit 50 shifts its processing to that at Step S5.

At the Step S5, the control unit 50 makes the display panel unit 20 display the second message indicating that the ground removal processing has been invalidated to the user in the display mode shown in FIG. 4. In the state in which the display panel unit 20 displays the second message, when the user recognizes the fact to operate the display panel unit 20 (by depressing the “OK” portion in FIG. 4), or when the control unit 50 recognizes that a predetermined time has elapsed, the control unit 50 shifts its processing to that at Step S9.

At the Step S6, the control unit 50 judges whether a direction to perform the ground removal processing is input onto the ground removal direction button 11 or not. When the ground removal processing is input onto the ground removal direction button 11 (Step S6; YES), the control unit 50 shifts its processing to that at Step S7. When the ground removal processing is not input onto the ground removal direction button 11 (Step S6; NO), the control unit 50 shifts its processing to that at Step S8.

At the Step S7, the control unit 50 executes the ground removal processing of the image data received from the scanner unit 30, and then shifts its processing to that at the Step S9.

At the Step S8, the control unit 50 invalidates the ground removal processing by making the ground removal processing be prohibited, and then shifts its processing to that at the Step S9.

At the Step S9, the control unit 50 makes the printer unit 40 execute copying based on the image data that has been subjected to the image processing. In this case, the printer unit 40 records the original image that has been read by the scanner unit 30 onto the recording medium, and outputs the recording medium as a copy. Then, the control unit 50 ends the copying control processing.

The aforesaid image forming apparatus 1 prohibits the ground removal processing by the processing at the Step S4 when a security watermark pattern is detected from the original image by the processing at the Step S2. Consequently, even if a direction to perform the ground removal processing is input onto the ground removal direction button 11, the ground removal processing is prohibited, and it can be prevented consequently that the security watermark pattern is treated as a ground to be removed carelessly. Hence, the concealed text of the security watermark can be surely left when a second copy is produced. Moreover, when third copying, fourth copying and so forth are performed using the image forming apparatus 1 of the present embodiment, the forgery copying of the original can be surely prevented in the third copying, the fourth copying and so forth.

### Second Embodiment

Next, a second embodiment according to the present invention is described. The case where whether the security watermark removal processing is prohibited or not is determined based on whether the security watermark has been detected or not has been illustrated to be described in the first embodiment, but, in the second embodiment, the case where density changing processing is prohibited or not is determined based on whether a security watermark has been detected or not is illustrated to be described. In addition, the same components as those of the first embodiment are denoted by the same reference marks, and their descriptions are omitted in the following descriptions.

For example, the control unit 50 according to the second embodiment is configured so that, when the control unit 50 receives a signal directing the performance of density changing processing from the density changing direction button 12 of the operation panel unit 10, the control unit 50 may perform the density changing processing to the image data. The density changing processing means image processing to change the brightness of the whole image by performing the γ correction processing to the image data in the whole density region. In addition, the density changing direction button 12 is the input portion according to the present invention for directing whether the density changing processing is performed to the image data generated by the reading of the scanner unit 30 or not. The density changing direction button 12 is configured to be able to set a predetermined density value after a change.

Then, the control unit 50 is configured so that, when a direction to perform the density changing processing to change the density to be thinner than a reference value is input onto the density changing direction button 12, the control unit 50 may prohibit the density changing processing if the control unit 50 recognizes that there is a security watermark pattern in the original image based on the image data as a reading result of the scanner unit 30.

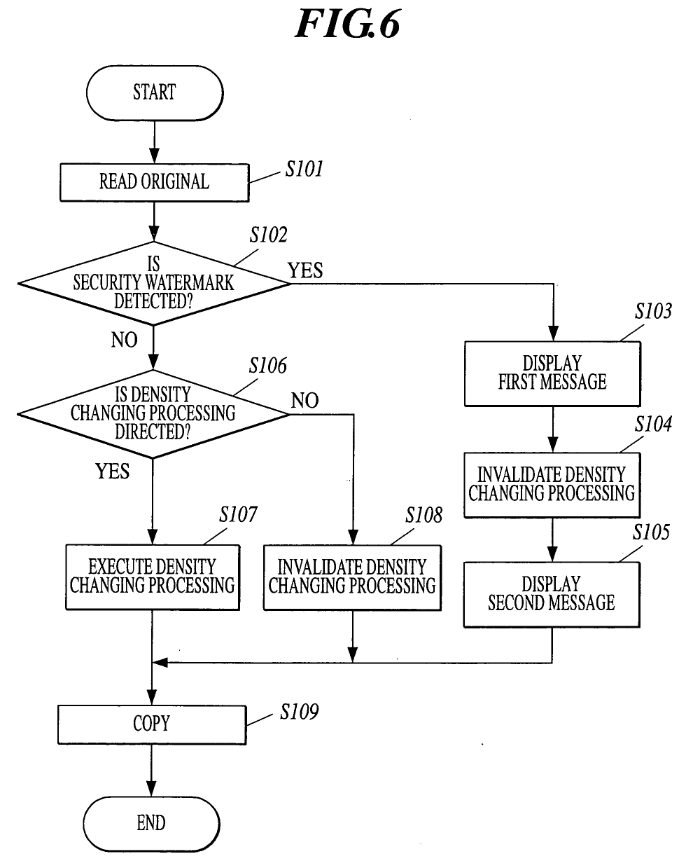

The copying control processing executed by the control unit 50 in the image forming apparatus 1 is concretely described with reference to FIG. 6.

When a signal directing the start of copying an original image is transmitted by an operation of the operation panel unit 10 by a user, the control unit 50 recognizes that fact to makes the scanner unit 30 start to read the original image (Step S101). In this case, whenever the scanner unit 30 reads the original image, the scanner unit 30 sequentially performs the image processing of the reading result, and transmits the reading result after the image processing to the control unit 50 as image data.

Next, at Step S102, the control unit 50 judges whether there is some security watermark pattern in the original image or not based on the image data transmitted from the scanner unit 30.

When the control unit 50 recognizes that there is no repetition pattern in the original image, or when the control unit 50 recognizes that there is an repetition pattern in the original image but the repetition pattern does not agree with any of the registered patterns, the control unit 50 recognizes that there is no security watermark pattern in the original image (Step S102; NO), and shifts its processing to that at Step S106. On the other hand, when there is a repetition pattern of any of the registered patterns in the original image as the result of the judgment at the Step S102, the control unit 50 recognizes that there is a security watermark pattern in the original image (Step S102; YES), and shifts its processing to that at Step S103.

At the Step S103, the control unit 50 makes the display panel unit 20 display a first message indicating the detection of the security watermark pattern in the original image in the display mode shown in FIG. 3. In the state in which the display panel unit 20 displays the first message, when the user recognizes the display to operate the display panel unit 20 (by depressing the “OK” portion in FIG. 3), or when the control unit 50 recognizes that a predetermined time has passed, the control unit 50 shifts its processing to that at Step S104.

At the Step S104, the control unit 50 invalidates the density changing processing of the density changing direction button 12 by making the density changing processing be prohibited lest the density changing processing should be executed even if a direction to perform the density changing processing to make the density be thinner than the reference value, and shifts its processing to that at Step S105.

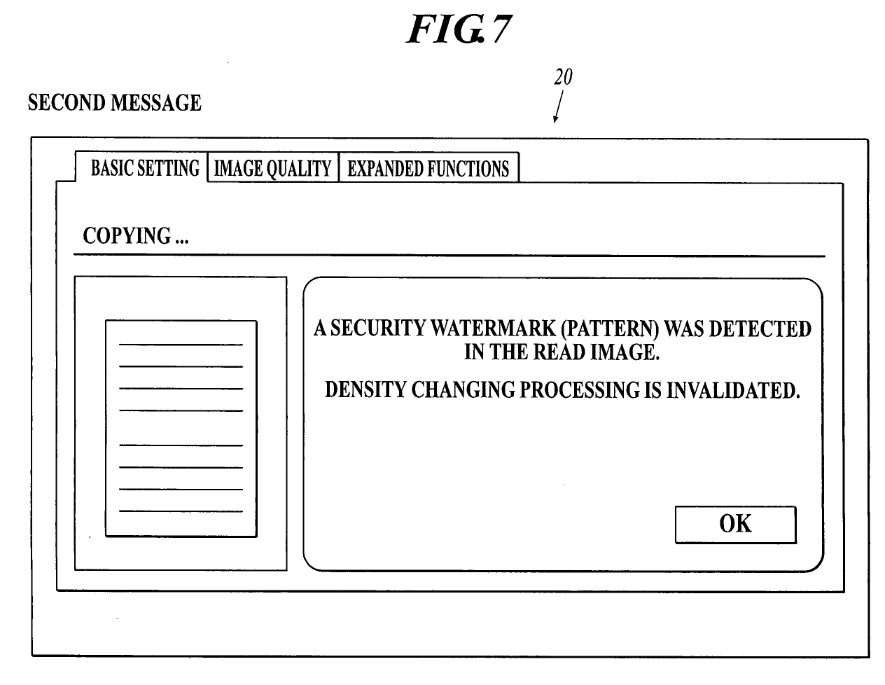

At the Step S105, the control unit 50 makes the display panel unit 20 display a second message indicating the fact of invalidating the density changing processing to the user in the display mode shown in FIG. 7. In the state in which the display panel unit 20 displays the second message, when the user recognizes the fact to operate the display panel unit 20 (by depressing the “OK” portion in FIG. 7), or when the control unit 50 recognizes that a predetermined time has passed, the control unit 50 shifts its processing to that at Step S109.

At the Step S106, the control unit 50 judges whether a direction of the density changing processing is input onto the density changing direction button 12 or not. When the direction is input onto the density changing direction button 12 (Step S106; YES), the control unit 50 shifts its processing to that at Step S107. When the direction is not input onto the density changing direction button 12 (Step S106; NO), the control unit 50 shifts its processing to that at Step S108.

At the Step S107, the control unit 50 executes the density changing processing to the image data received from the scanner unit 30, and shifts its processing to that at the Step S109.

At the Step S108, the control unit invalidates the density changing processing by making the density changing processing be prohibited, and shifts its processing to that at Step S109.

At the Step S109, the control unit 50 makes the printer unit 40 execute copying based on the image data that has been subjected to the image processing. In this case, the printer unit 40 records the original image read by the scanner unit 30 to a recording medium, and outputs the recording medium as a copy. Then the control unit 50 ends the copying control processing.

The aforesaid image forming apparatus 1 prohibits the density changing processing by the processing at the Step S104 when a security watermark pattern is detected from an original image at the processing at the Step S102. Consequently, the density changing processing is prohibited even if a direction to perform the density changing processing to makes the density be thinner than the reference value is input onto the density changing direction button 12, and the security watermark pattern can be prevented from being printed. Consequently, when a second copy is produced, the concealed text of the security watermark can be surely left. Moreover, if third copying, fourth copying and so forth are performed using the image forming apparatus of the present embodiment, the forgery copying of an original can be surely prevented in the third copying, the fourth copying and so forth.

In addition, the present invention is not limited to the embodiments mentioned above, and various improvements and alternations of design may be performed without departing from the sprit and the sphere of the present invention.

For example, in any of the embodiments mentioned above, when a direction to perform the ground removal processing is input from the ground removal direction button 11, or when a direction to perform the ground removal or to make the density be thinner than the reference value is input from the density changing direction button 12, the ground removal processing or the processing of making the density be thinner than the reference value is prohibited if the control unit 50 recognizes that there is a security watermark pattern in the original image based on the image data as the result of reading by the scanner unit 30. However, the control unit 50 may stop the outputting (copying in both of the embodiments) in place of the prohibition. Thereby, the outputting of the image the security watermark of which has been removed can be prevented, and the forgery copying of an original can be surely prevented. Hereupon, it is preferable to make the display panel unit 20 display the fact that “the outputting of the image is stopped because there is the possibility that a security watermark is removed” when the outputting of the image is stopped.

Moreover, not only the mode of outputting an image to a recording medium, but also the mode of electrically or magnetically delivering (outputting) the image data obtained from the scanner unit 30 to an external device other than the image forming apparatus 1 may be adopted as the outputting of the image. When the image data is output to the outside, the image data may be output as a general purpose file format such as the TIF format, PDF format or the like, or may be output in a dedicated format that only a predetermined image processing apparatus or a predetermined image forming apparatus can treat.

What is claimed is:

1. An image reading apparatus, comprising:
a scanner unit to read an original image to generate image data;
an input unit to accept a direction to perform or not to perform predetermined image processing which affects image density to the image data; and
a control unit to perform the predetermined image processing to the image data based on the direction on the input unit,
wherein the control unit prohibits performing the predetermined image processing to the image data and outputting the image data when the control unit recognizes a presence of a security watermark in the original image based on the image data.

2. The apparatus of claim 1, wherein the control unit prohibits performing the predetermined image processing to the image data and outputting the image data by prohibiting the predetermined image processing or by stopping outputting the image data which has been subjected to the predetermined image processing.

3. The apparatus of claim 1, wherein the predetermined image processing is to perform ground removal.

4. The apparatus of claim 1, wherein the predetermined image processing is to make image density be thinner.

5. An image forming apparatus comprising:
the image reading apparatus of claim 1; and
a printer unit to record an image on a recording medium based on the image data to output the recording medium as a copy.

6. An image reading method of an image reading apparatus which comprises: a scanner unit to read an original image to generate image data; an input unit to accept a direction to perform or not to perform predetermined image processing which affects image density to the image data; and a control unit to perform the predetermined image processing to the image data based on the direction on the input unit, the method comprising the steps of:
prohibiting performing the predetermined image processing to the image data and outputting the image data when the control unit recognizes a presence of a security watermark in the original image based on the image data.

7. The method of claim 6, wherein the prohibiting step is performed by prohibiting the predetermined image processing or by stopping outputting the image data that has been subjected to the predetermined image processing.

8. The method of claim 6, wherein the predetermined image processing is to perform ground removal.

9. The method of claim 6, wherein the predetermined image processing is to make image density be thinner.
